(19) United States
(12) Patent Application Publication
(10) Pub. No.: US 2006/0187082 A1
(43) Pub. Date: Aug. 24, 2006

(54) Processing observed data received over a network

(76) Inventors: Santiago Estefania, Sugar Land, TX (US); Travis Allen Johnson, Houston, TX (US); Ronald Leon, Maracaibo (VE); Robert Gregor Villalobos, Maturin (VE)

Correspondence Address: Schwegman, Lundberg, Woessner & Kluth, P.A., P.O. Box 2938, Minneapolis, MN, 55402, US

(21) Appl. No.: 11/305,823

(22) Filed: Dec. 16, 2005

Related U.S. Application Data
(63) Continuation of application No. 11/141,261, filed on May 31, 2005.
Application No. 11/141,261 is a continuation of application No. 10/930,708, filed on Aug. 31, 2004, now abandoned.

(51) Int. Cl. G08B 5/22

(52) U.S. Cl. 340/825.36

(57) ABSTRACT

One embodiment includes an apparatus that comprises a storage medium to store a database. The apparatus also includes a port to receive, over a network, data related to observations at a work site. The apparatus includes a processor to store the data into the database.

### RELATED APPLICATION

This application is a continuation under 37 CFR 1.53(b) of U.S. patent application Ser. No. 11/141,261, filed May 31, 2005, which is a continuation under 37 CFR 1.53 (b) of U.S. patent application Ser. No. 10/930,708, filed Aug. 31, 2004, which application is incorporated herein by reference and made a part hereof.

### TECHNICAL FIELD

The application relates generally to data processing. In particular, the application relates to processing of observed data received over a network.

### BACKGROUND

Workplace safety and environmental pollution prevention are critically important issues across different types of businesses. A number of behavior-based safety programs have been developed to focus on unsafe behaviors. One example of such a program developed over twenty years ago is the Safety Training Observation Program (STOP). The premise of STOP is that workplace injuries can be prevented through observation of one's own activities as well as activities of other workers. STOP requires that workers act by establishing a dialog with the person making an unsafe act and write down on cards the unsafe behavior seen and the corrective and preventive actions taken. Such cards are typically submitted to operational and Health and Safety Environment(???) management of the organization. Those managers manually review all of the different cards received and provide recommendations or institute new procedures across the entire business. There may be a long time delay from the point such observations are generated until actions are taken as consequences of management review.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a network 102 can be located in FIG. 1. However, reference numbers are the same for those elements that are the same across different Figures. In the drawings:

FIG. 1 illustrates a network for processing observed data, according to some embodiments of the invention.

FIG. 2 illustrates a system for processing observed data, according to some embodiments of the invention.

FIGS. 3A-3B illustrate computer devices for processing observed data over a network, according to some embodiments of the invention.

FIG. 4 illustrates a flow diagram for processing observation data received over a network, according to some embodiments of the invention.

FIG. 5 illustrates a flow diagram for processing observation data received over a network that includes management review, according to some embodiments of the invention.

FIG. 6 illustrates a flow diagram for processing observation data received over a network that includes sharing of such data among multiple business entities, according to some embodiments of the invention.

FIGS. 7A-7B illustrate Graphical User Interface (GUI) screens for inputting data related to an observation, according to some embodiments of the invention.

FIGS. 7C-7F illustrate GUI screens that display the number of observations based on different selection criteria, according to some embodiments of the invention.

FIGS. 7G-7I illustrate GUI screens that display a more detailed description of the observation, according to some embodiments of the invention.

FIG. 7J illustrates a GUI screen that displays reactions of people for given time periods, according to some embodiments of the invention.

FIG. 7K illustrates a GUI screen that displays a more detailed description of particular persons that may input an observation into the system, according to some embodiments of the invention.

FIG. 7L illustrates a GUI screen that displays a more detailed description of particular observations that a given person may input into the system, according to some embodiments of the invention.

FIG. 7M illustrates a GUI screen that allows the manager to input a recommended corrective action, according to some embodiments of the invention.

FIG. 7N illustrates a GUI screen that includes the recommended corrective action by a manager for an observation, according to some embodiments of the invention.

FIG. 7O illustrates a GUI screen that allows the manager to enter an action on a recommended corrective action for an observation, according to some embodiments of the invention.

### DETAILED DESCRIPTION

Methods, apparatus and systems for processing observed data over a network are described. In the following description, numerous specific details are set forth, However, it is understood that embodiments of the invention may be practiced without these specific details. In other instances, well-known circuits, structures and techniques have not been shown in detail in order not to obscure the understanding of this description.

Embodiments of the invention allow for the electronic reporting and statistical and/or heuristic analysis of observations of behavior that is unsafe and non-environmentally friendly (performed by personnel at different work sites). In some embodiments, observations are defined to include acts of recognizing or noting of an occurrence. The observations may be of unsafe or non-environmentally friendly activity by different persons. With regard to observations of unsafe activity, an example of such activity may include the failure to wear personal protective equipment for different parts of the body (e.g., the head, eyes, face, ears, respiratory system, hands, arms, trunk, feet, legs, etc.). For example, the observation may relate to the lack of wearing of proper eye wear. Another example of the activity that may be observed includes the reactions of people. In particular, the reactions of people may indicate that unsafe or non-environmentally friendly activity may have been occurring. Examples of such reactions may include the adjusting of equipment, changing positions, rearranging a job, stopping a job, attaching grounds, lockouts, etc.

In some embodiments, observed activity may include the positions of people. Examples of such positions may include being caught in, on or between objects, falling, contacting temperature extremes, contacting electric current, inhaling, absorbing, overexertion, repetitive movements, etc. In some embodiments, observed activity may relate to the tools and equipments. For example, a person may be using the wrong tool for the job, using the tool incorrectly or in an unsafe condition. In some embodiments, observed activity may relate to procedures and orderliness. For example, the procedures or orderliness may be inadequate, not understood or not followed.

With regard to non-environmentally friendly observations, examples of such activity may include the filling or transferring of liquids or solids improperly, the storing of solid or liquid materials or equipment incorrectly, or labeling improperly the products and materials or the lack of proper identification of such products and materials. Other examples may include washing and cleaning of tools and equipment using inappropriate products, using inappropriate procedures to clean tools and equipment, wasting of products or materials, or using inappropriately or not using dust control systems. Still further examples may include managing inappropriately the waste materials after operation activities, storing waste (toxic and non-toxic) improperly or maintaining inappropriately or not maintaining the oil/water separate and/or drains.

Persons may input the data related to such observations into any of a number of different electronic devices. Such devices may transmit this data over a network (such as the World Wide Web) to a centralized server for storage therein. Embodiments may allow for the graphical display of these observations based on a number of different categories, such as geographic location, product service line, client, time period, etc. Further, embodiments may allow for the sorting of the observations for each of the different personnel and rank such personnel according to the number of observations reported.

Accordingly, some embodiments allow individual persons (e.g., supervising parties, such as managers for a given work site, group, etc.) to perform a trend analysis for such observations stored in the centralized server. For example, a manager may determine that personnel at a given work site for the last six months has been trending away from the use of required personal protection equipment. Therefore, the manager may require additional training for such personnel. Accordingly, embodiments allow persons to identify potential causes and take preventive actions, thereby avoiding injuries or costly accidents that may negatively impact the operations at the work site.

Because such data is stored in a centralized server, in some embodiments, the data related to the observations may be shared among different independent business entities. For example, a first business entity may receive statistics regarding a number of observations of unsafe activity at a given type of work site for other business entities. Such statistics enables the first business entity to take preventive action based on the observations made at work sites of other business entities. In some embodiments, such sharing may be performed independent of the identities of the business entities.

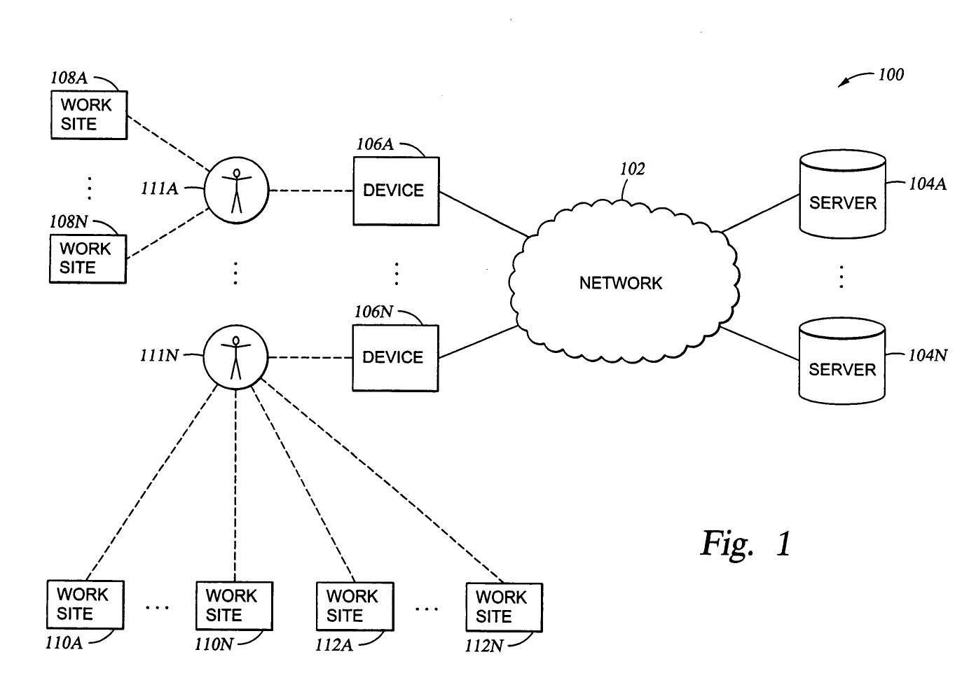

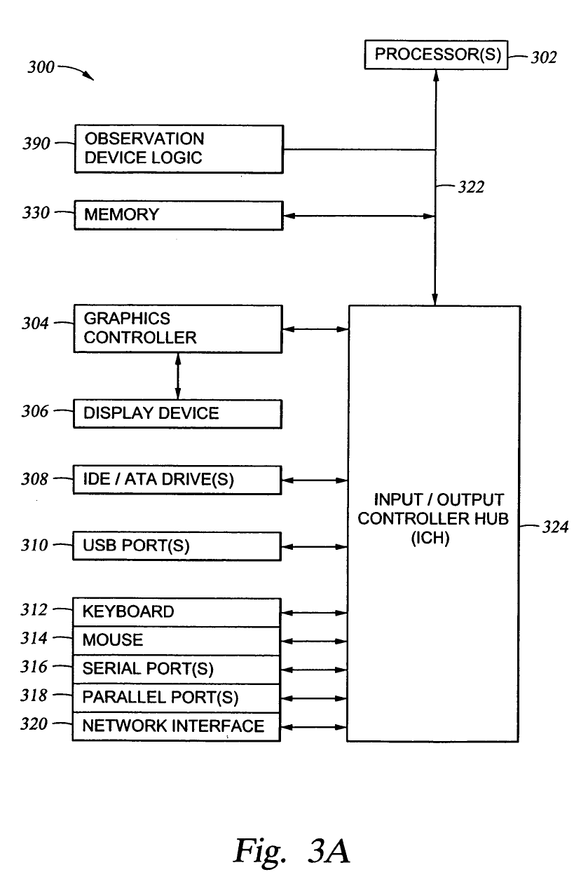

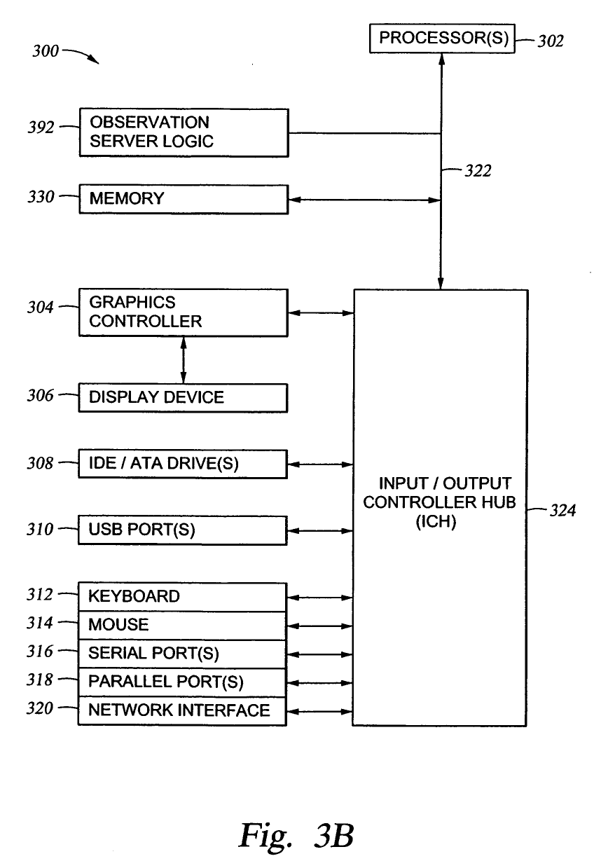

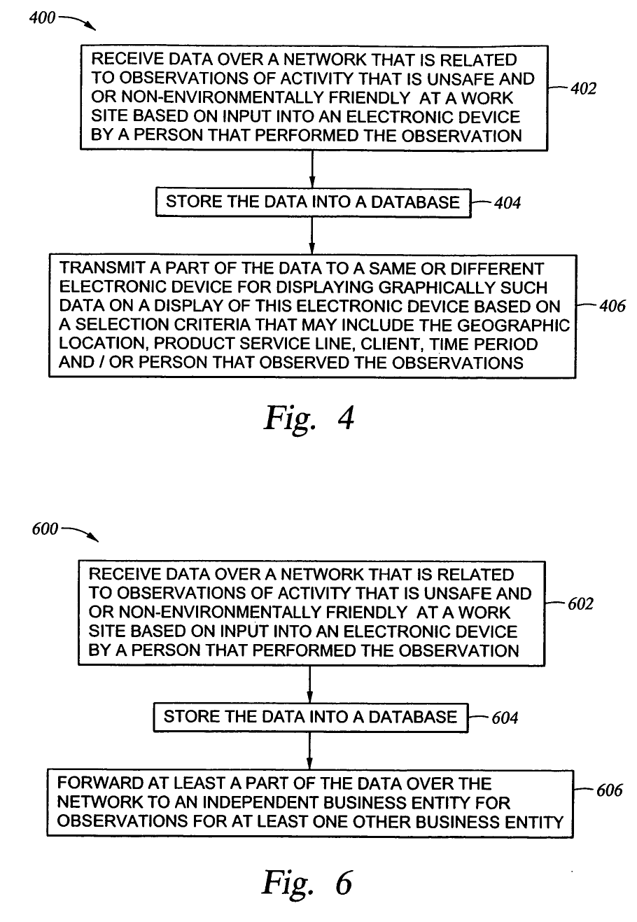

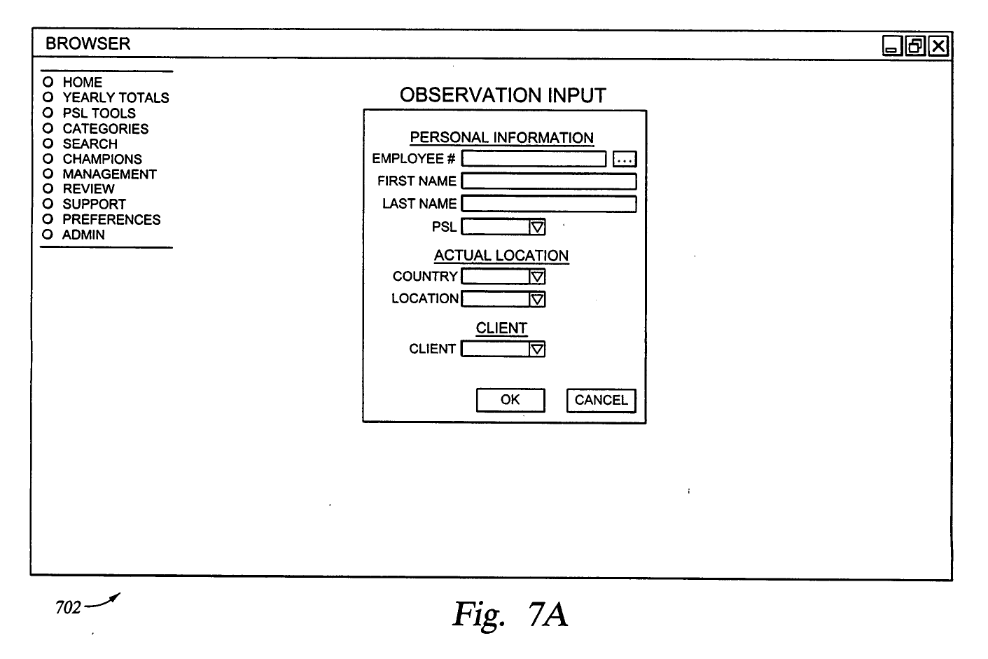

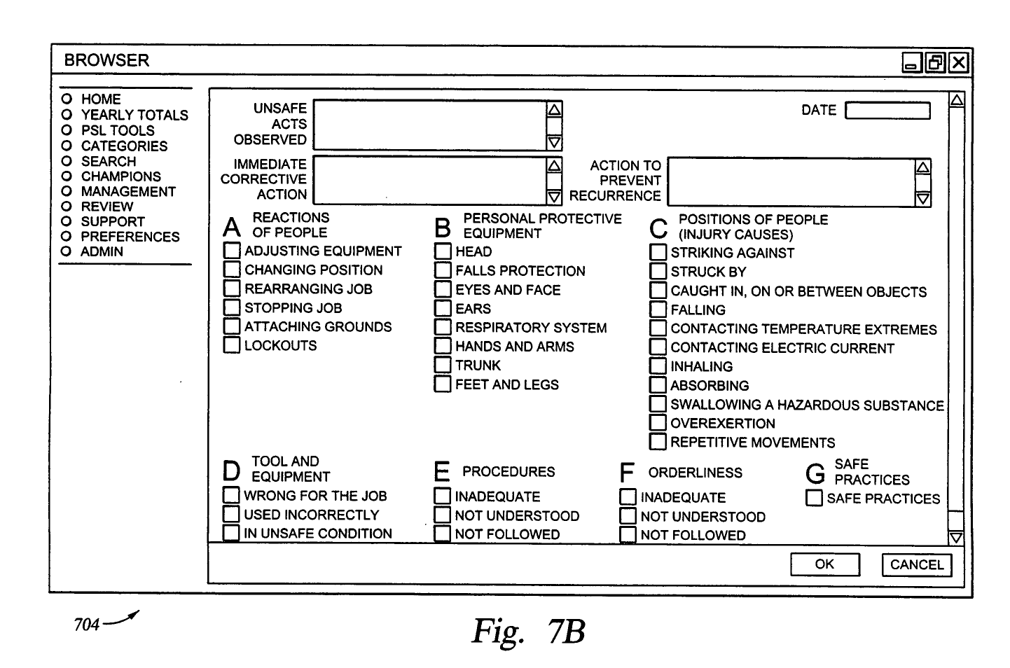

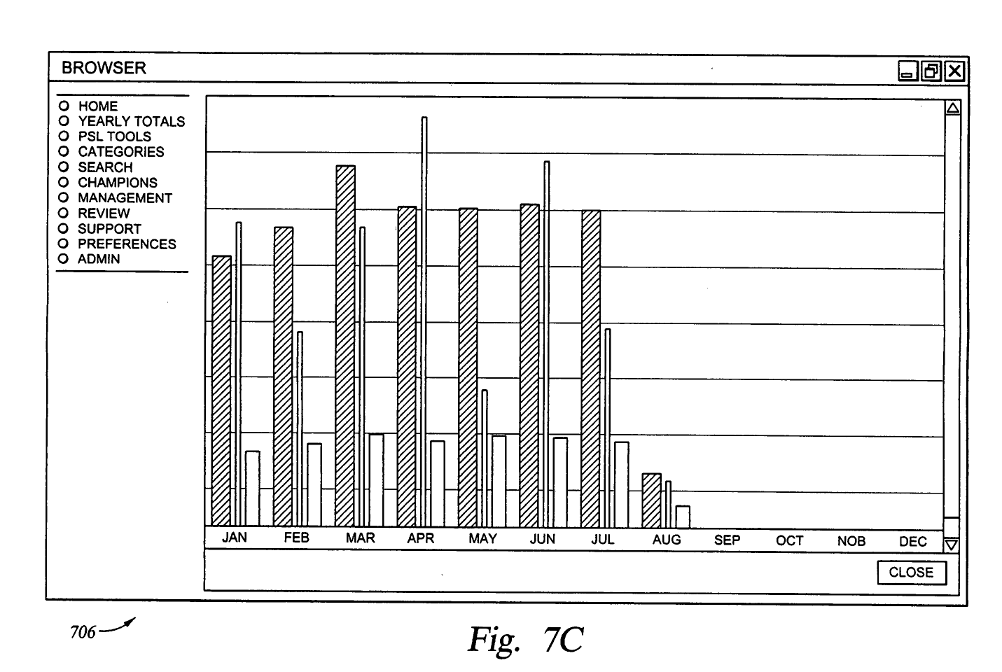

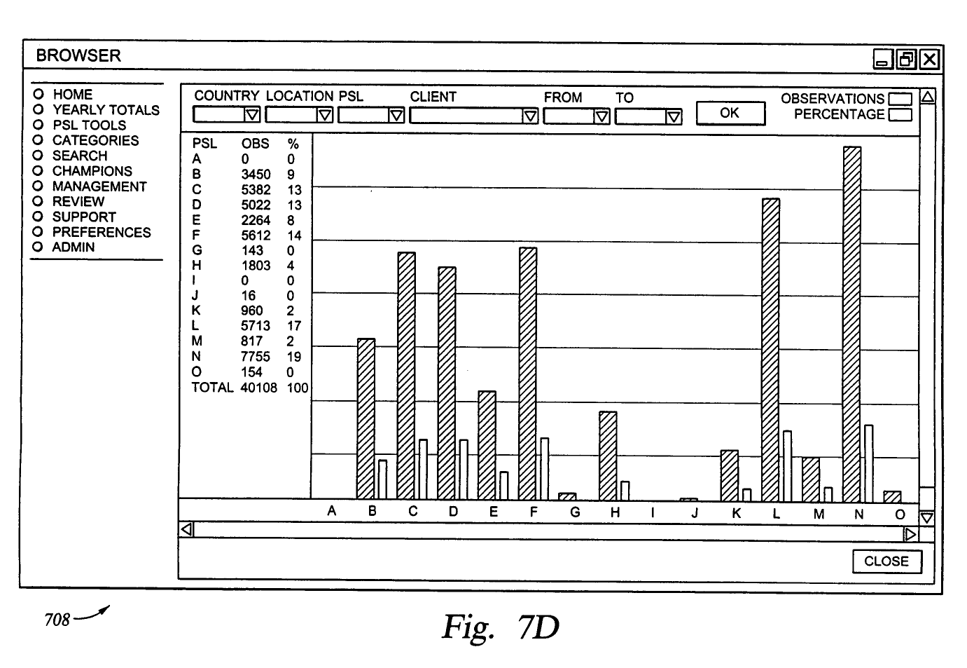

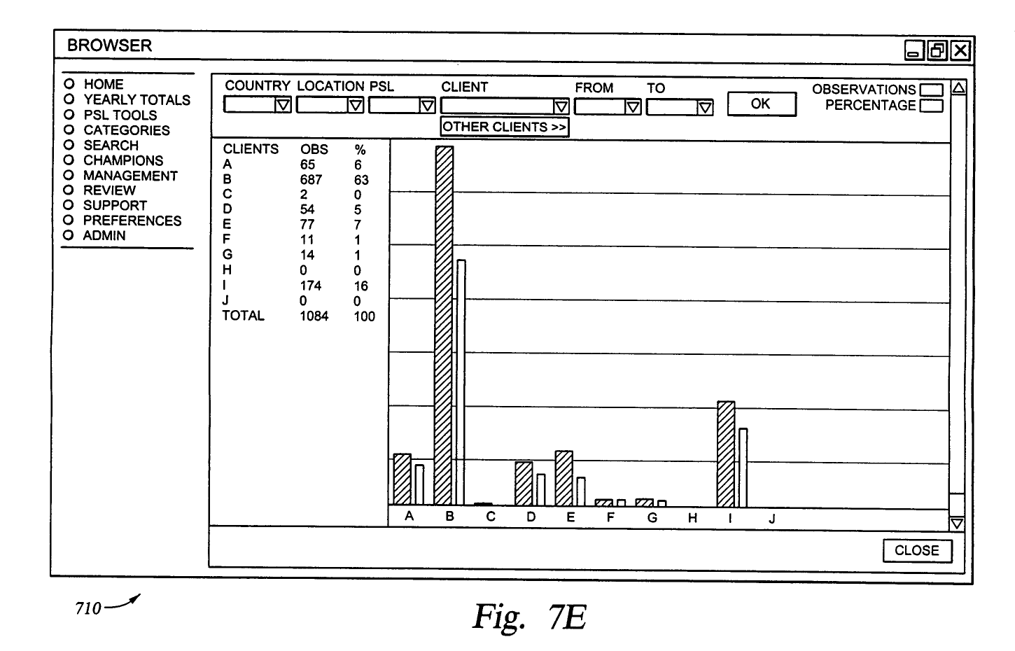

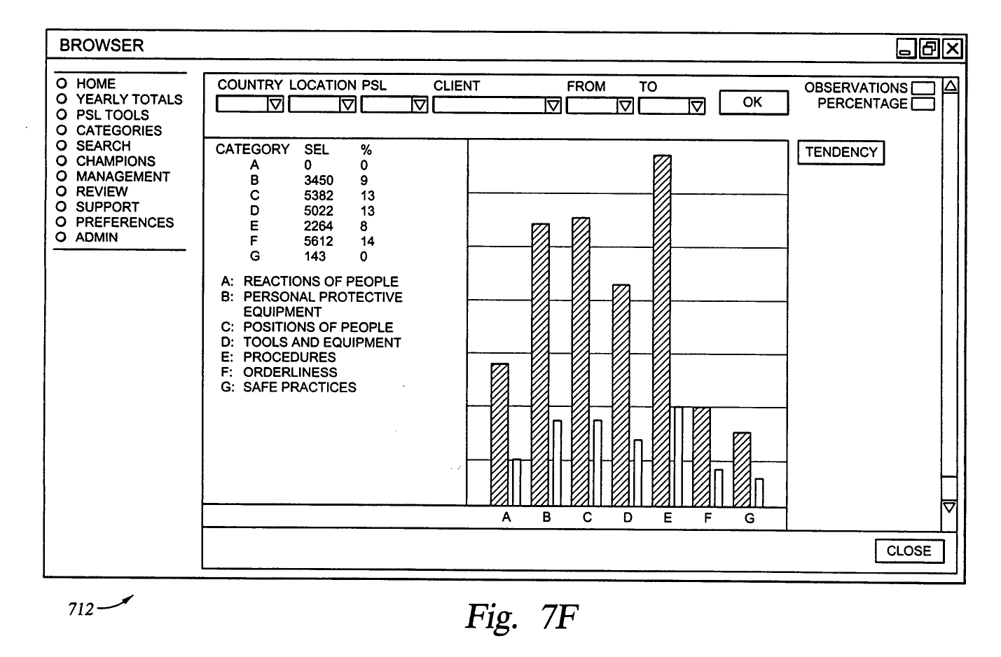

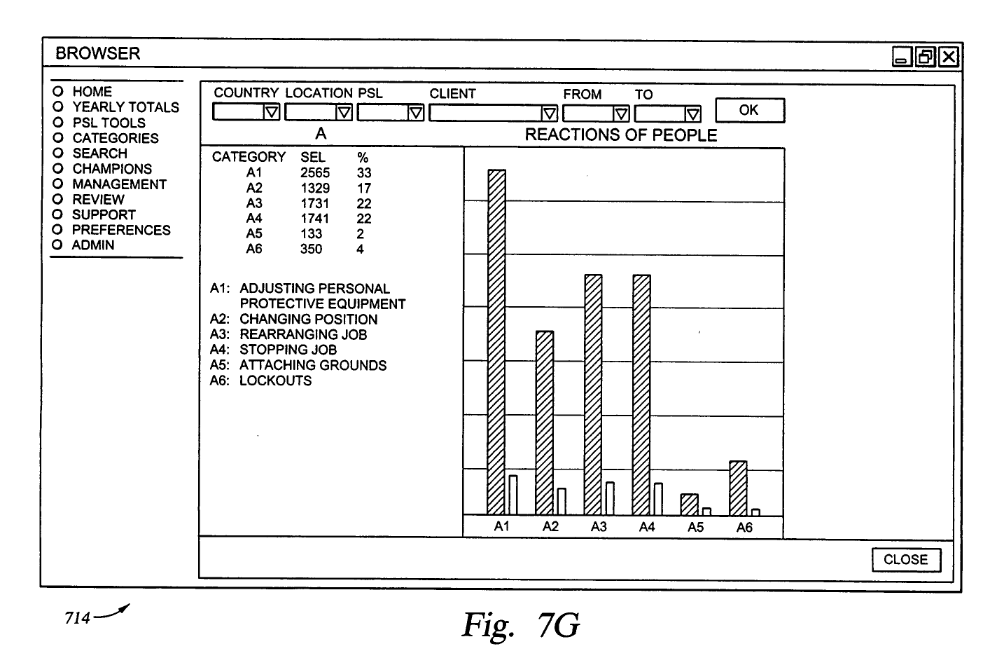

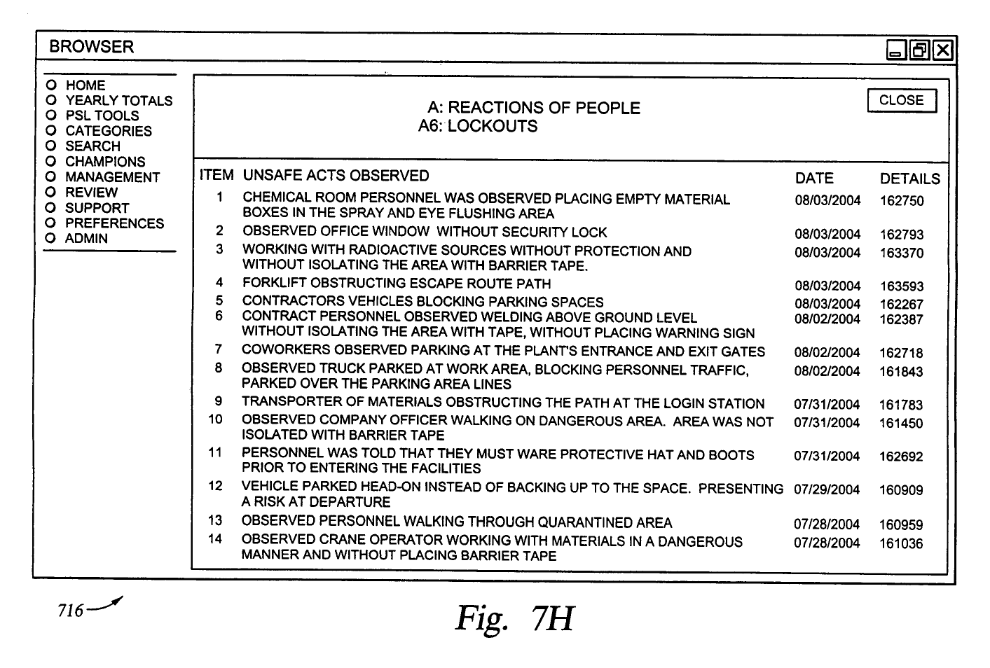

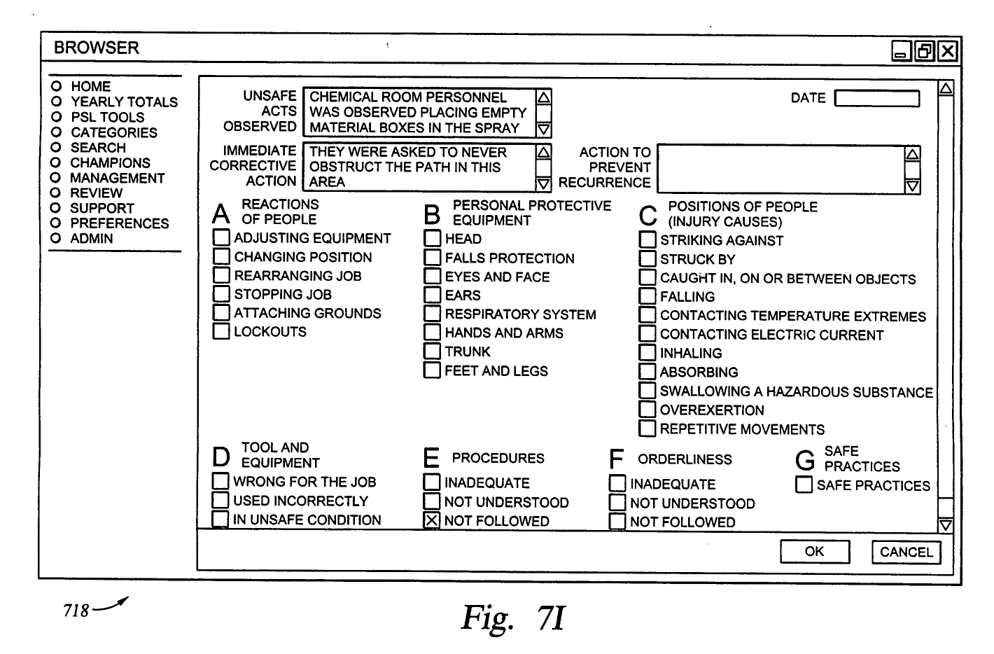

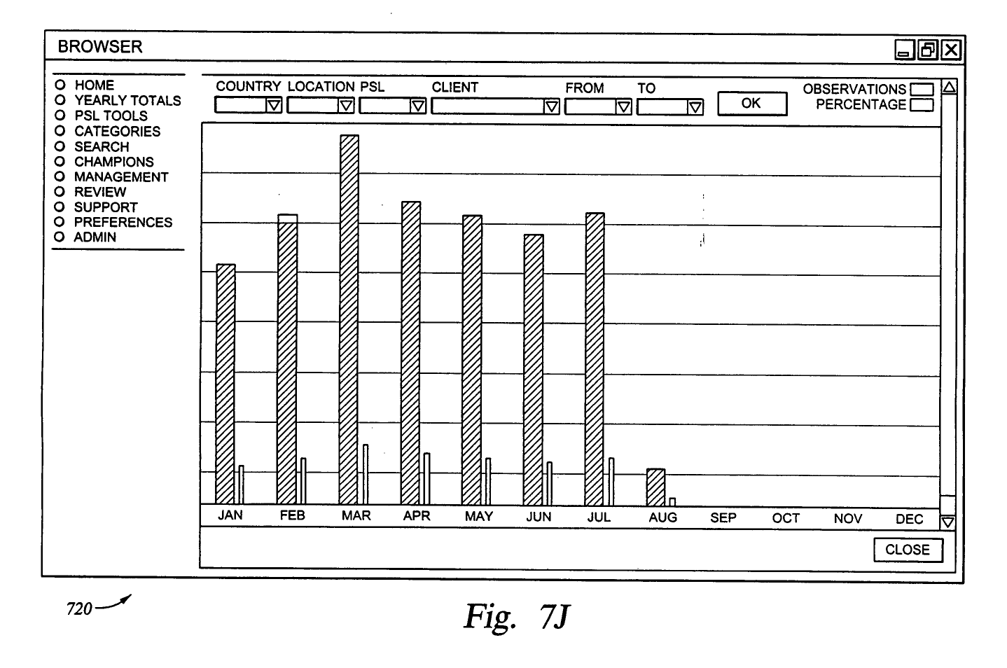

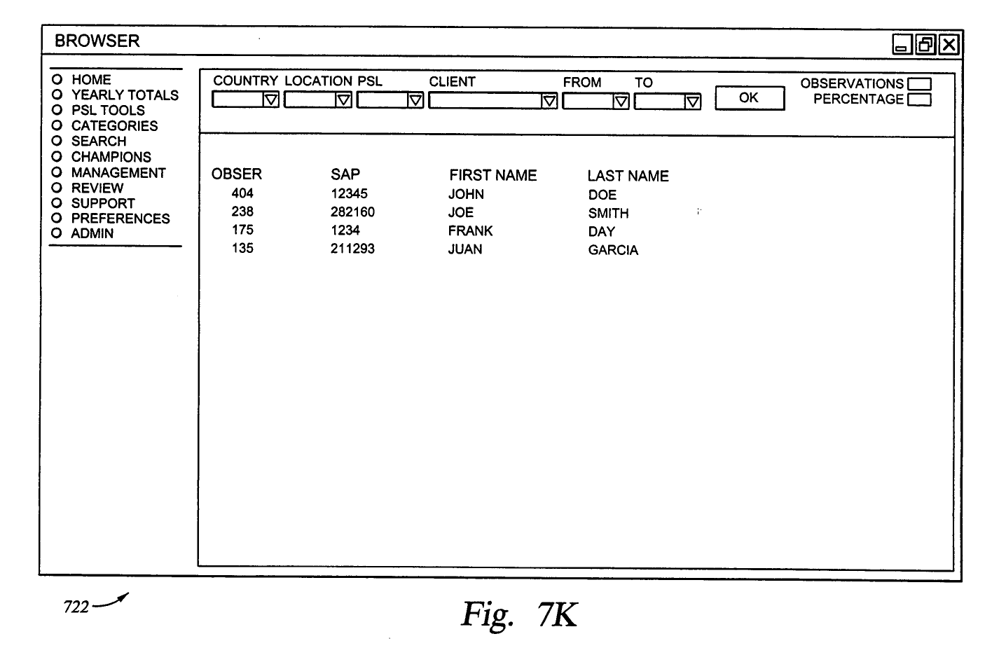

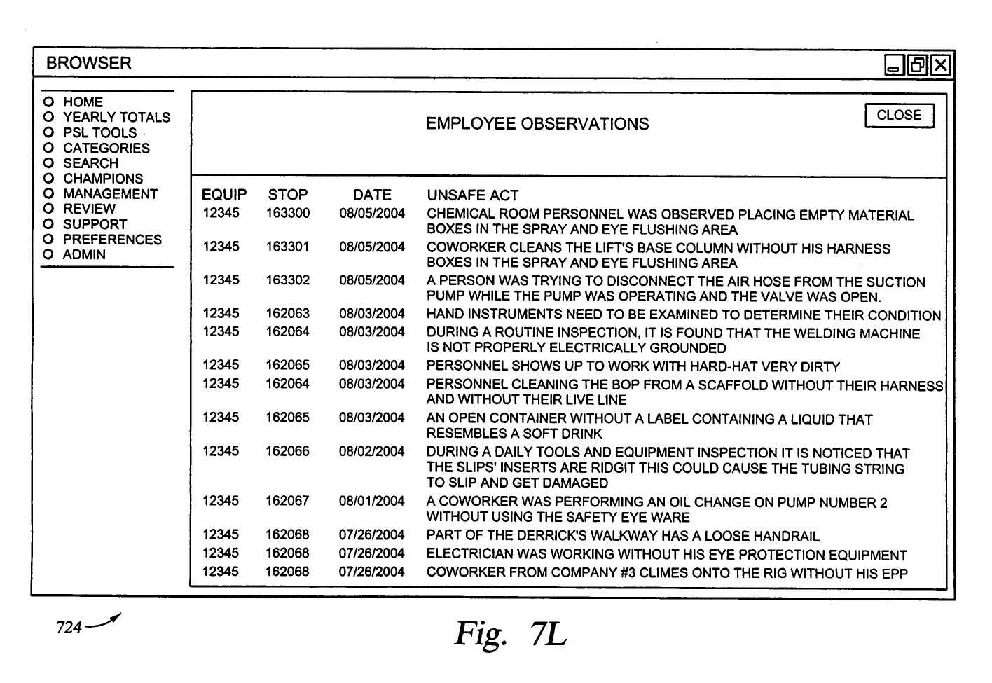

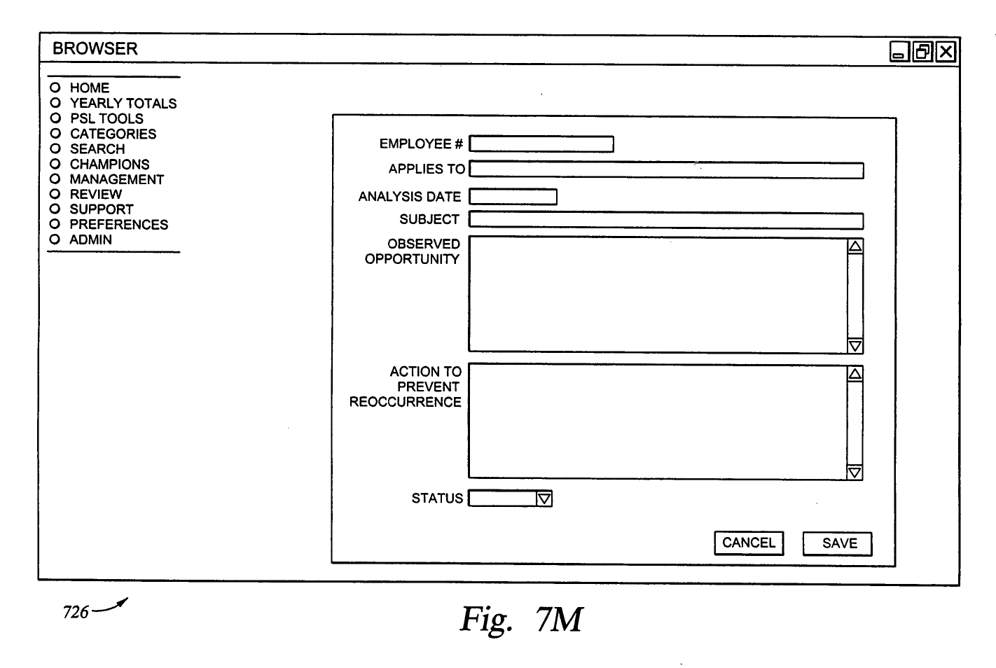

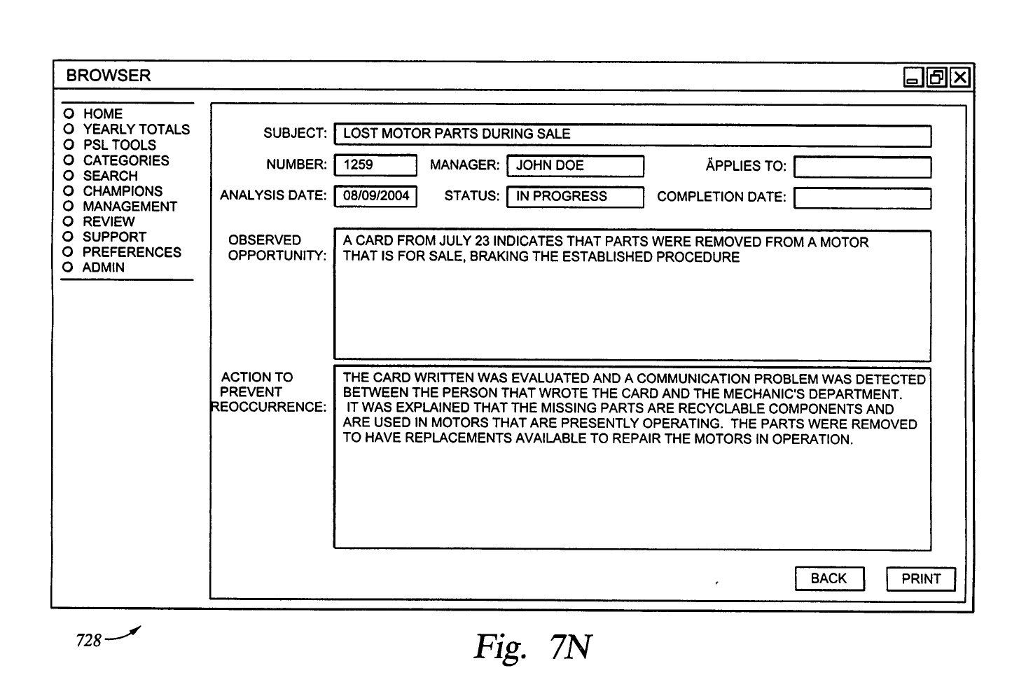

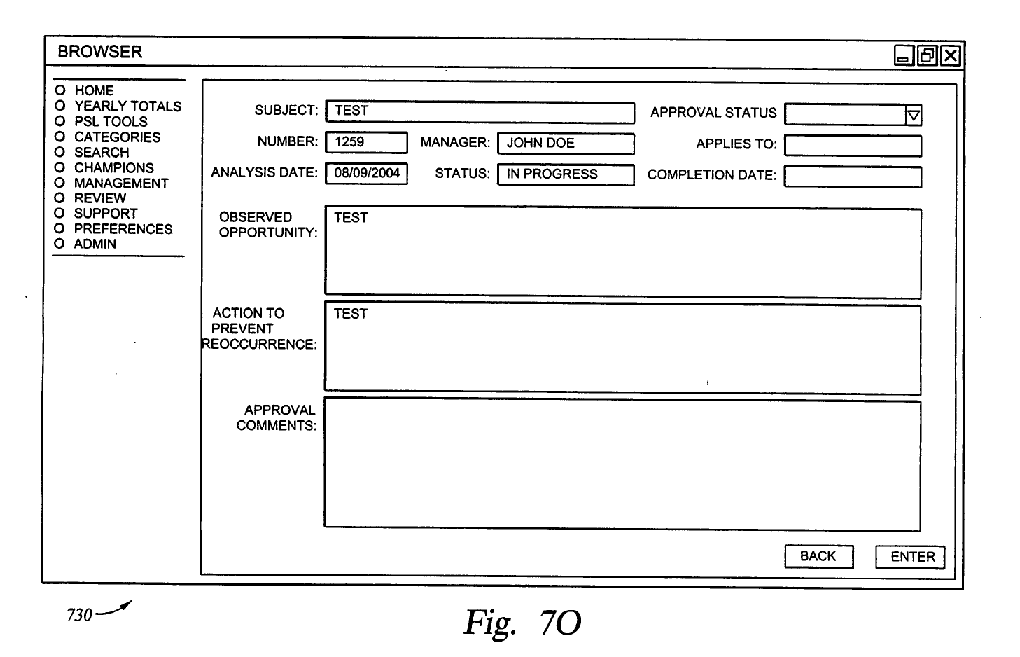

FIGS. 1 and 3A-3B illustrate a system and apparatus for processing observed data transmitted over a network, respectively, according to some embodiments of the invention. FIGS. 4-6 illustrate a number of flow diagrams for the operations for processing observed data transmitted over a network, according to some embodiments of the invention. FIGS. 7A-7O illustrate a number of Graphical User Interface (GUI) screens that may be used for displaying and inputting data related to the observations, according to some embodiments of the invention. The descriptions of the GUI screens are interspersed, where appropriate, throughout the description of the FIGS. 1-6. Moreover, the GUI screens shown in FIG. 7A-7O are specific for observations of unsafe activity. However, such GUI screens are by way of example and not by way of limitation, as similar GUI screen may be used for observations that are non-environmentally friendly.

FIG. 1 illustrates a network for processing observed data, according to some embodiments of the invention. In particular, FIG. 1 illustrates electronic devices 106A-106N and servers 104A-104N, which are coupled together through a network 102. The electronic devices 106A-106N may include one to any number of such devices coupled to the network 102. Similarly, the servers 104A-104N may include one to any number of such servers coupled to the network 102. While different embodiments may have different types of interfaces for the electronic devices 106A-106N and the servers 104A-104N, in some embodiments, the interface may be Web-based, wherein the network 102 is the World Wide Web (WWW). The network 102 may be of different types, such as a local area network (LAN), other types of a wide area network (WAN), etc.

Further, the network 102 may be a combination of different networks that provide communication among the servers 104A-104N and the electronic devices 106A-106N. The electronic devices 106 and the servers 104 may communicate with the network 102 through wired and/or wireless communication. Moreover, to allow for increased security regarding the communications between the electronic devices 106 and the servers 104, virtual private networks (VPNs) within the network 102 may be established between a given electronic device 106 and a given server 104.

FIG. 1 also illustrates a number of work sites (work sites 108A-108N, work sites 110A-110N and work sites 112A-112N) and a number of persons (persons 111A-111N). The persons 111A-111N may observe activity that is considered unsafe and/or non-environmentally friendly at the work sites 108A-108N, the work sites 110A-110N and the work sites 112A-112N. The persons 111A-111N may input data related to such observations into one of the electronic devices 106A-106N. Software executing on the electronic devices 106A-106N may transmit such data for storage into a database in one of the servers 104A-104N. FIGS. 7A-7B illustrate Graphical User Interface (GUI) screens for inputting data related to an observation, according to some embodiments of the invention. FIG. 7A illustrates a GUI screen 702 for inputting data related to the person that observed the observation (e.g., employee identification, name, location that the observation was observed, etc.). FIG. 7B illustrates a GUI screen 704 for inputting data related to the observation (reactions of people, personal protective equipment, etc.).

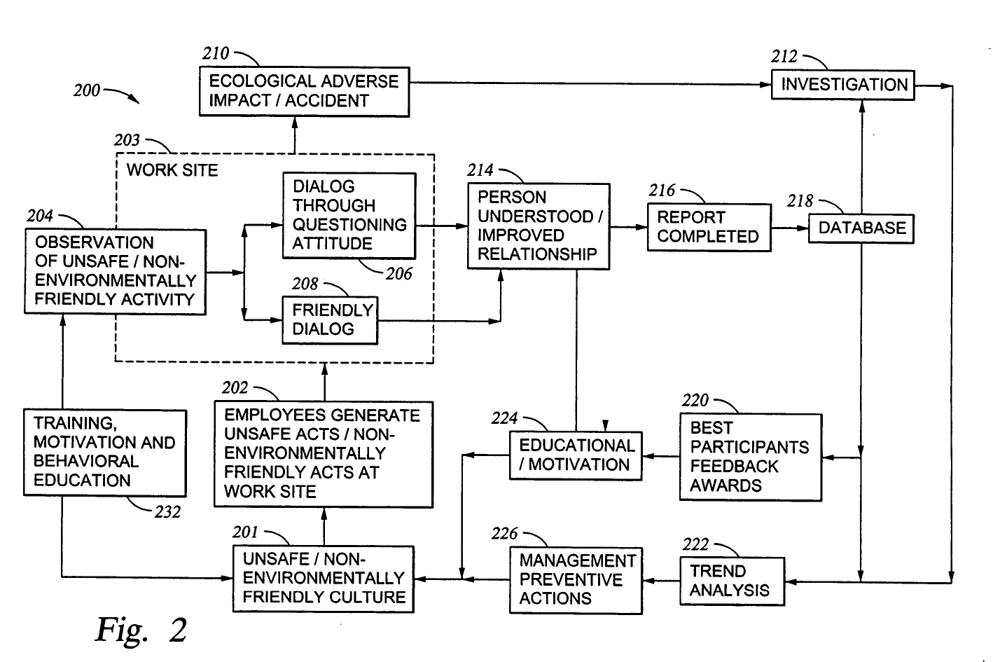

FIG. 2 illustrates a system for processing observed data, according to some embodiments of the invention. In particular, FIG. 2 illustrates a system 200 that includes a work site 203 and a database 218 for storage of data related to observations of unsafe or non-environmentally friendly activity made at the work site 203. As shown, the system 200 includes a number of blocks that illustrate actions based on the observations made at the work site 203. A block 201 includes a unsafe/non-environmentally friendly culture. Such culture contributes to unsafe/non-environmentally friendly activity by employees (which is illustrated by the input into block 202). A block 204 includes the observation of the unsafe/non-environmentally friendly activity. Such observation may be made by other employees, supervisors, managers, etc. As shown in a block 206 and a block 208, there may be dialog between the person making the observation (i.e., the observer) and the person that performed the activity. Such dialog may question the attitude of the person performing the activity if the person making the observation is the supervisor or manager. Alternatively or in addition, the dialog may be friendly, wherein the person making the observation informs the person who performed the activity that the observation was made.

The output of the blocks 206 and 208 may lead to a block 214, wherein there is an understanding by the person that performed the unsafe/non-environmentally friendly of such activity. Moreover, such dialog may lead to an improved relationship between the observer and the person being observed. The output of the block 214 may result in an input into the block 216, which includes the completion of a report regarding the observation of the activity. Additionally, the output of the block 214 may result in an input into the block 224, which includes education and motivation of the persons that performed the activity. As described in more detail below, the completion of the report may be performed by inputting data related thereto into an electronic device by the observer. Such data is inputted into the database 218, which may be over a network, as shown in FIG. 1.

Regardless of the number of observations made, a block 210 illustrates that an ecologically adverse impact or accident may occur at the work site 203. The output of the block 210 is input into a block 212, which includes an investigation of the ecologically adverse impact or accident. As shown, data related to the observations stored in the database 218 may be used as input into the investigation. A result of the investigation is input into a block 222, which includes a trend analysis regarding the ecologically adverse impact/accidents as well. Moreover, the trend analysis may include data regarding the observations from the database 218. The result of the trend analysis may include preventive actions performed by management (block 226). Such actions may include new procedures related to the activity/accidents, etc. The result of the management preventive actions are input into the unsafe/non-environmentally friendly culture in order to change such culture.

Best participants/feedback awards may be made to those persons that are most involved in the reporting of observations (block 220). Such awards may be based on the data stored in the database 218. The result of these awards may include education/motivation of workers (as shown by the input into the block 224). The result of the education/motivation may be input into the unsafe/non-environmentally friendly culture in order to change such culture. A block 232 illustrates training, motivation and behavioral education, which may be input into the observations (block 204) and the culture (201). This training, motivation and behavioral education may allow for more observations at block 204 and a change in the culture at block 201. The reporting and storage of these observations as well as the transmission of data related thereto to supervising parties are described in more detail below.

FIGS. 3A-3B illustrate computer devices for processing observed data over a network, according to some embodiments of the invention. In particular, FIG. 3A and FIG. 3B illustrate, respectively, the electronic devices 106 and the servers 104, according to some embodiments of the invention. As shown, FIG. 3A includes an observation device logic 390, while FIG. 3B includes an observation server logic 392.

In some embodiments, the observation device logic 390 and the observation server logic 392 may be instructions executing within the processor(s) 302. Therefore, the observation server logic 392 and the observation device logic 390 may be stored in a machine-readable medium that are a set of instructions (e.g., software) embodying any one, or all, of the methodologies described herein. For example, the observation server logic 392 and the observation device logic 390 may reside, completely or at least partially, within the memory 330, the processor(s) 302, one of the IDE/ATA drive(s) 308, etc. In some embodiments, the observation server logic 392 and the observation device logic 390 may be hardware logic. In an embodiment, the observation server logic 392 and the observation device logic 390 may be a combination of software, firmware and/or hardware.

As illustrated in FIGS. 3A-3B, a computer device 300 also comprises processor(s) 302, a memory 330, a processor bus 322, and an input/output controller hub (ICH) 324. The processor(s) 302, the memory 330, and the ICH 324 are coupled to the processor bus 322. The processor(s) 302 may comprise any suitable processor architecture. The computer device 300 may comprise one, two, three, or more processors, any of which may execute a set of instructions in accordance with embodiments of the invention.

The memory 330 stores data and/or instructions, and may comprise any suitable memory, such as a random access memory (RAM). For example, the memory 330 may be a Static RAM (SRAM), a Synchronous Dynamic RAM (SDRAM), DRAM, a double data rate (DDR) Synchronous Dynamic RAM (SDRAM), etc. A graphics controller 304 controls the display of information on a display device 306, according to an embodiment of the invention.

The ICH 324 provides an interface to Input/Output (I/O) devices or peripheral components for the computer device 300. The ICH 324 may comprise any suitable interface controller to provide for any suitable communication link to the processor(s) 302, the memory 330 and/or to any suitable device or component in communication with the ICH 324. In some embodiments of the invention, the ICH 324 provides suitable arbitration and buffering for each interface.

In an embodiment, the ICH 324 provides an interface to one or more suitable Integrated Drive Electronics (IDE)/Advanced Technology Attachment (ATA) drive(s) 308, such as different types of storage mediums (e.g., a hard disk drive (HDD) or compact disc read only memory (CD ROM) drive) or to suitable universal serial bus (USB) devices through one or more USB ports 310. In an embodiment, the ICH 324 also provides an interface to a keyboard 312, a mouse 314, one or more suitable devices through one or more parallel ports 318 (e.g., a printer), and one or more suitable devices through one or more serial ports 316. In some embodiments, a database may be stored in one or more of the IDE/ATA drives 308, the memory 330, a cache internal to the processor(s) 302, etc. In some embodiments, the ICH 324 also provides a port or a network interface 320 through which the computer device 300 can communicate with other computers and/or devices. The port 320 may be used to transmit and receive data related to observations related to activity that is unsafe and/or non-environmentally friendly.

FIG. 4 illustrates a flow diagram for processing observation data received over a network, according to some embodiments of the invention. In particular, FIG. 4 illustrates a flow diagram 400 that illustrates the operations for processing of data related to observations of unsafe activity and/or observations related to actions that are non-environmentally friendly at a work site. Such data may be input into one of the electronic devices 106 by a person that observes such observations at a work site. In some embodiments, software that allows for a Web-based interface may be executing on the electronic devices 106 to allow such persons to input data. Accordingly, such data may be transmitted over a network, such as the World Wide Web, to a centralized server for storage into a database. Therefore, some embodiments allow for data related to observations across any of a number of different work sites. For example data related to the different observations may be received for different geographic locations, different product service lines and/or different clients.

In block 402, data is received over a network that is related to observations of activity that is unsafe and/or non-environmentally friendly at a work site based on input into an electronic device by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 404.

In block 404, the data is stored in a database. With reference to the embodiment of FIG. 3B, the observation server logic 392 may store the database in one of the IDE/ATA drive(s) 308. In some embodiments, the database may include a number of different data structures for storage of the data. For example, the database may include an observation table that stores the received observations therein. The database may also include a table for storage of data related to the observer. For example, this table may include an entry for the different employees in a given business entity that may transmit observations over the network. Such an entry may include the employee identification, name of employee, the product service line on which the employee is working on, the geographic location of the work site where the employee works and the client for which the employee works. In some embodiments, when the data is received over the network, the observation server logic 392 may verify that the employee has an entry in this table and that the data therein is accurate. Accordingly, if the employee is working on a different product service line, in a different geographic location and/or on a different client (relative to a previous time period when the table was updated), such entry may be updated. In some embodiments, the data for different business entities and/or groups within a business entity may be separated into different databases. Such databases may be stored on a same server or a number of different servers. Control continues at block 406.

In block 406, a part of the data is transmitted over the network to a same or different electronic device for displaying graphically such data on a display of this electronic device based on a selection criteria that may include the geographic location, product service line, client, time period and/or the person that observed the observations. With reference to the embodiments of FIGS. 1 and 3B, the observation server logic 392 may transmit such data over the network 102 to one of the electronic devices 106. In some embodiments, the part of the data that is transmitted is based on a selection criteria by a person operating this electronic device. For example, a manager of a work site may review the different observations at their work site. Moreover, the manager of a particular work site may review the observations at a different work site in the same or different geographic region.

FIGS. 7C-7F illustrate GUI screens that display the number of observations based on different selection criteria, according to some embodiments of the invention. In particular, FIG. 7C illustrates a GUI screen 706 that displays the number of observations for the different months for the year 2004, the number of persons that have made observations and the number of observations for the most active observer. For example, for January 2004, 4833 observations were made, 1281 persons made observations and the number of observations for the person that inputted the most observations was 75. FIG. 7D illustrates a GUI screen 708 that displays the number of observations for particular product service lines for a given time period. For example, the number of observations for the product service line L&P is 5382 (13% relative to all of the other product service lines).

FIG. 7E illustrates a GUI screen 710 that displays the number of observations for the year 2004 across a number of different clients. For example, the number of observations for the client BP is 687 (63% relative to all of the other clients). FIG. 7F illustrates a GUI screen 712 that displays the number of observations for given categories of observations (e.g., personal protective equipment) for the year 2004. For example, the number of observations for the observation type B (personal protective equipment) is 14795 (20% relative to all of the other categories).

Moreover, additional data may be transmitted over the network based on a request for the user reviewing the data received on the electronic device 106. For example, FIGS. 7G-7I illustrate GUI screens that display a more detailed description of the observation, according to some embodiments of the invention. Returning to FIG. 7F, in operation, the user (e.g., the manager) may select (e.g., double click) a bar on the graph, which is representative of all of the different observations of a given category. This may cause a request to be transmitted over the network 102 for the detailed entries of all of the observations of that given category. The observation server logic 392 may return the data shown in a GUI screen 714 of FIG. 7G. Furthermore, the user may select a particular entry on the GUI screen 714 (e.g., the A6 column). This may cause a request to be transmitted over the network 102 for that particular entry. The observation server logic 392 may return the data shown in a GUI screen 716 of FIG. 7H. As shown, the observations for the subcategory “A6-Lockouts” are displayed. The user may select a particular entry on the GUI screen 716 (e.g., the first entry). This may cause a request to be transmitted over the network 102 for that particular entry. The observation server logic 392 may return the data shown in a GUI screen 718 of FIG. 7I. As show, the particular observation is displayed.

A person may have only observed a reaction to the person entering a given area. Such reaction may not have been an unsafe or non-environmentally friendly activity. In some embodiments, the person may enter data related to such reactions. FIG. 7J illustrates a GUI screen that displays reactions of people for given time periods, according to some embodiments of the invention. In particular, FIG. 7J illustrates a GUI screen 720 that displays the number of reactions inputted into the system for the year 2004 across the different months. Similar to the observations of unsafe activity in the GUI screens described above, farther GUI screens may be displayed for particular types of reactions.

Additionally, the part of the data transmitted over the network 102 may relate to employees and the number of observations such employees have made. For example, FIG. 7K illustrates a GUI screen that displays a more detailed description of particular persons that may input an observation into the system, according to some embodiments of the invention. FIG. 7L illustrates a GUI screen that displays a more detailed description of particular observations that a given person may input into the system, according to some embodiments of the invention.

In particular, FIG. 7K illustrates a GUI screen 722 that displays the number of observations for a given employee. The user may select one of the employees in the GUI screen 722 to display the particular observations by that employee. The observation server logic 392 may return the data shown in a GUI screen 724 of FIG. 7L, which may be displayed as shown. Additionally, the user may select one of the observations in the GUI screen 724 of FIG. 7L to display more details about a particular observation. The observation server logic 392 may return the data shown in the GUI screen 718 of FIG. 7I (described above). Therefore, as described, this operation in block 408 may continue to occur based on requests by the user of one of the electronic devices 106.

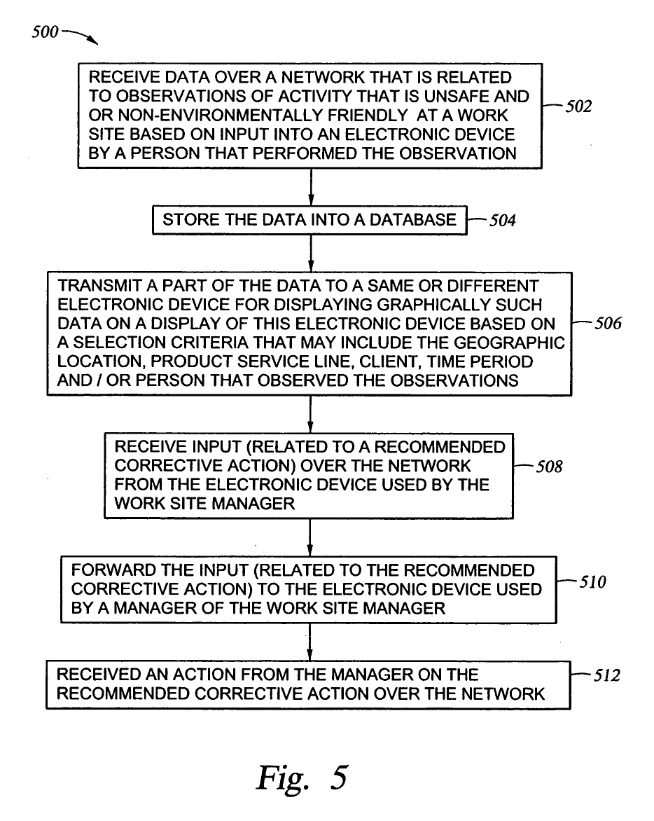

In some embodiments, a manager of a given work site or a given group of persons may review the observations entered into the system and make a recommended corrective action. For example, if there are a high number of observations related to not wearing of personal protection equipment, the manager may require additional training with regard to the wearing of such equipment. Moreover, in some embodiments, a given work site may include employees across a number of different businesses. Therefore, the recommended corrective action may be reviewed by a higher level manager prior to implementing of the recommended corrective action. In particular, a higher level manager may ensure that the recommended corrective action is appropriate in light of all of the requirements across the different business entities. A flow diagram of the communications over a network for such embodiments is now described. In particular, FIG. 5 illustrates a flow diagram for processing observation data received over a network that includes management review, according to some embodiments of the invention.

In block 502, data is received over a network that is related to observations of activity that is unsafe and/or non-environmentally friendly at a work site based on input into an electronic device by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 504.

In block 504, the data is stored in a database. With reference to the embodiment of FIG. 3B, the observation server logic 392 may store the database in one of the IDE/ATA drive(s) 308 (as described above). Control continues at block 506.

In block 506, a part of the data is transmitted over the network to a same or different electronic device for displaying graphically such data on a display of this electronic device based on a selection criteria that may include the geographic location, product service line, client, time period and/or the person that observed the observations. With reference to the embodiments of FIGS. 1 and 3B, the observation server logic 392 may transmit such data over the network 102 to one of the electronic devices 106. In some embodiments, the work site manager may be logged into their account on this electronic device 106. The part of the data that is transmitted is based on a selection criteria by the work site manager. Control continues at block 508.

In block 508, an input is received over the network from the electronic device used by the work site manager. The input is data related to a recommended corrective action for observations at a work site from a work site manager. With reference to the embodiments of FIGS. 1 and 3B, the observation server logic 392 may receive such data over the network 102. In some embodiments, the work site manager may be required to review the observations for a given time period and/or after N number of observations have been entered into the system. FIG. 7M illustrates a GUI screen that allows the manager to input a recommended corrective action, according to some embodiments of the invention. In particular, FIG. 7M illustrates a GUI screen 726 that allows a manager to input an “action to prevent recurrence” based on an “observed opportunity.” FIG. 7N illustrates a GUI screen that includes the recommended corrective action by a manager for an observation, according to some embodiments of the invention. With reference to the embodiment of FIG. 3B, the observation server logic 392 may store this input into a database in one of the IDE/ATA drive(s) 308 (as described above). Control continues at block 510.

In block 510, the input related to the recommended corrective action is forwarded over the network to the electronic device used by a manager of the work site manager. With reference to the embodiments of FIGS. 1 and 3B, the observation server logic 392 may forward this data over the network 102 to the electronic device 106 that the manager is using. In some embodiments, this data may be forwarded after a recommended corrective action is received by the server 104. This data may also be forwarded after N number of recommended corrective actions are received by the server 104, after a given time period, based on a request by the manager, etc. Control continues at block 512.

In block 512, an action from the manager on a recommended corrective action is received over the network. With reference to the embodiments of FIGS. 1 and 3B, the observation server logic 392 may receive this action over the network 102 from one of the electronic devices 106 that the manager is using to access their account. FIG. 7O illustrates a GUI screen that allows the manager to enter an action on a recommended corrective action for an observation, according to some embodiments of the invention. In particular, FIG. 7O illustrates a GUI screen 730 that allows a manager of a manager (such as a work site manger) to enter an action (such as approval, disapproval, approval with comments, disapproval with comments, etc.).

Accordingly, the manager may input data into the approval comments. Such data may be transmitted over the network 102 and received by the observation server logic 392.

As described, the operations of the flow diagram 500 allow for management review of observations and to allow a manager to input into the system recommended corrective actions to the observations of unsafe activity. While described such that the recommended corrective actions are reviewed by another layer of management, in some embodiments, such review is not performed. For example, if all of the personnel at a given work site are part of a same business entity, such review may not be performed. In some embodiments, if there are personnel from different business entities at a given work site, such review is performed. Such review may ensure that the recommended corrective actions are in accord with the procedures for all of the different business entities.

In some embodiments, the system may perform the operations described above for a number of different independent business entities. The data for the observations for one business entity may be of interest to the other business entities. Because the system includes a centralized database for the different business entities, such data may be shared among such entities. Such operations are now described. In particular, FIG. 6 illustrates a flow diagram for processing observation data received over a network that includes sharing of such data among multiple business entities, according to some embodiments of the invention.

In block 602, data is received over a network that is related to observations of activity that is unsafe and/or non-environmentally friendly at a work site based on input into an electronic device by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 604.

In block 604, the data is stored into a database. With reference to the embodiment of FIG. 3B, the observation server logic 392 may store the database in one of the IDE/ATA drive(s) 308 (as described above). Control continues at block 607.

In block 607, data is forwarded over the network to an independent business entity for observations for at least one other independent business entity. With reference to the embodiment of FIGS. 1 and 3B, the observation server logic 392 may forward such data. In some embodiments, the observation server logic 392 may forward the data based on a request from a person at the independent business entity. The observation server logic 392 may forward the data based on given thresholds for the observations. For example, if X number of observations for a given business entity exceeds a threshold, this number is forwarded to at least one other independent business entity. In some embodiments, the data is forwarded, independent of the identity of the business entity associated with the data. Accordingly, such data may allow the independent business entities receiving the data to avoid accidents related to observations of unsafe or non-environmentally friendly activity that occurred at the work sites of other business entities.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for processing observed data over a network, in accordance with some embodiments of the invention. A number of figures show flow diagrams illustrating operations for processing observed data over a network, in accordance with some embodiments of the invention. The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. An apparatus comprising:
a storage medium to store a database;
a port to receive, over a network, data related to observations of unsafe activity at a work site based on input into an electronic device; and
a processor to store the data into the database.

2. The apparatus of claim 1, wherein the processor is to retrieve a part of the data from the database based on a selection criteria that is from a group consisting of name of geographic location, name of product, name of client, time period or name of person that observed the unsafe activity, the processor to transmit the part of the data through the port to the electronic device or a different electronic device coupled to the network to graphically display the part of the data on a display of the electronic device or the different electronic device.

3. The apparatus of claim 1, wherein the observations of unsafe activity are to be input to the electronic device through a Web-based interface.

4. The apparatus of clam 1, wherein the observations of unsafe activity comprise observations identified by the Safety Training Observation Program.

5. The apparatus of claim 1, wherein the input into the electronic device is by a person that observed the unsafe activity.

6. The apparatus of claim 1, wherein the observations of unsafe activity include at least an observation of a reaction of a person, an observation of a lack of personal protective equipment, an observation of a position of a person, or an observation of activity related to a tool.

7. An apparatus comprising:
a storage medium to store a database;
an input/output (I/O) port to receive, over a network, data related to observations that are non-environmentally friendly at a work site based on input into a first electronic device by a person that observed the observation; and
a processor to store the data into the database.

8. The apparatus of claim 7, wherein the processor is to retrieve a part of the data from the database based on a selection criteria that is from a group consisting of name of geographic location, name of product, name of client, time period or name of person that observed the unsafe activity, the processor to transmit the part of the data through the I/O port to a second electronic device coupled to the network to graphically display the part of the data on a display of the second electronic device.

9. The apparatus of claim 7, wherein the network is a wide area network.

10. The apparatus of claim 7, wherein the network is the World Wide Web.

11. The apparatus of claim 10, wherein the observations are to be input to the first electronic device through a Web-based interface.

12. The apparatus of claim 7, wherein the observations include at least an observation of an improper fill or transfer of a liquid or solid, an observation of an improper storage of a solid or liquid, an observation of improper label of a product, an observation of a clean operation of a tool with an inappropriate product, an observation of an inappropriate produce to clean a tool, or an observation of an inappropriate management of waste material.

13. An apparatus comprising:
a storage medium to store a database;
a port to receive, over a network, data related to observations at a work site based on input into a first electronic device, wherein the port is to receive, over the network, from a second electronic device, an input related to a recommended corrective action for the observations from a work site manager; and
a processor to store the data into the database.

14. The apparatus of claim 13, wherein persons from multiple business entities work at the work site

15. The apparatus of claim 13, wherein the processor is to forward through the port and over the network the input related to the recommended corrective action to a third electronic device for review by a manager of the work site manager.

16. The apparatus of claim 15, wherein the port is to receive, over the network, an action from the manager on the recommended corrective action back from the third electronic device.

17. The apparatus of claim 16, wherein the action from the manager comprises an approval of the recommended corrective action from the manager.

18. The apparatus of claim 16, wherein the action from the manager comprises a rejection of the recommended corrective action from the manager.

19. The apparatus of claim 13, wherein the observations include a number of observations of unsafe activity.

20. The apparatus of claim 19, wherein the number of observations of unsafe activity include at least an observation of a reaction of a person, an observation of a lack of personal protective equipment, an observation of a position of a person, or an observation of activity related to a tool.

21. The apparatus of claim 13, wherein the observations include a number of observations of non-environmentally friendly activity.

22. The apparatus of claim 21, wherein the number of observations of non-environmentally friendly activity include at least an observation of an improper fill or transfer of a liquid or solid, an observation of an improper storage of a solid or liquid, an observation of improper label of a product, an observation of a clean operation of a tool with an inappropriate product, an observation of an inappropriate produce to clean a tool, or an observation of an inappropriate management of waste material.

23. An apparatus comprising:
a storage medium to store a database;
a port to receive, over a network, data related to observations at work sites for a number of independent business entities based on input into an electronic device; and
a processor to store the data into the database, wherein the processor is to forward through the port and over the network to one of the number of independent business entities, a statistical analysis related to the observations for the at least one of the other of the number of independent business entities, independent of identity of the at least one of the other of the number of independent business entities.

24. The apparatus of claim 23, wherein the observations include a number of observations of unsafe activity.

25. The apparatus of claim 24, wherein the number of observations of unsafe activity include at least an observation of a reaction of a person, an observation of a lack of personal protective equipment, an observation of a position of a person, or an observation of activity related to a tool.

26. The apparatus of claim 23, wherein the observations include a number of observations of non-environmentally friendly activity.

27. The apparatus of claim 26, wherein the number of observations of non-environmentally friendly activity include at least an observation of an improper fill or transfer of a liquid or solid, an observation of an improper storage of a solid or liquid, an observation of improper label of a product, an observation of a clean operation of a tool with an inappropriate product, an observation of an inappropriate produce to clean a tool, or an observation of an inappropriate management of waste material.

28. An apparatus comprising:
a port to receive data related to at least one observation made at a work site; and
a processor to receive the data and forward the data through the port or a different port over a network for storage in a database of a server.

29. The apparatus of claim 28, wherein the data is forwarded from the database based on a selection criteria that is from a group consisting of name of geographic location, name of product, name of client, time period or name of person that observed the observation.

30. The apparatus of claim 28, wherein the observations are to be input to the port through a Web-based interface.

31. The apparatus of clam 28, wherein the observations comprise observations identified by the Safety Training Observation Program.

32. The apparatus of claim 28, wherein the data is to be input into the port by a person that observed the at least one observation.

33. The apparatus of claim 28, wherein the at least one observation includes a number of observations of unsafe activity.

34. The apparatus of claim 33, wherein the number of observations of unsafe activity include at least an observation of a reaction of a person, an observation of a lack of personal protective equipment, an observation of a position of a person, or an observation of activity related to a tool.

35. The apparatus of claim 28, wherein the at least one observation includes a number of observations of non-environmentally friendly activity.

36. The apparatus of claim 35, wherein the number of observations of non-environmentally friendly activity include at least an observation of an improper fill or transfer of a liquid or solid, an observation of an improper storage of a solid or liquid, an observation of improper label of a product, an observation of a clean operation of a tool with an inappropriate product, an observation of an inappropriate produce to clean a tool, or an observation of an inappropriate management of waste material.
